(19) United States
(12) Patent Application Publication
(10) Pub. No.: US 2010/0031296 A1
(43) Pub. Date: Feb. 4, 2010

(54) System and Method for Using Short Message Service Text Messaging to Schedule a Recording of a Television Program

(75) Inventors: Mark A. Elias, Eastpointe, MI (US); Sherry Soja-Molloy, Taylor, MI (US)

Correspondence Address: AT&T Legal Department - LNA;Attn: Patent Docketing, Room 2A- 207, One AT & T Way, Bedminster, NJ, 07921, US

(73) Assignee: AT&T INTELLECTUAL PROPERTY I, L.P., Reno, NV (US)

(21) Appl. No.: 12/183,698

(22) Filed: Jul. 31, 2008

(51) Int. Cl. G06F 3/00

(52) U.S. Cl. 725/54

(57) ABSTRACT

A system and method for using short message service text messaging to schedule a recording of a television program. A first short message service text message associated with a request for a list of television programs scheduled to be provided is received. A second short message service text message associated with the list of television programs scheduled to be provided is sent. A third short message service text message associated with a record request for a selected television program in the list of television programs is received. The record request for the selected television program is sent to a digital video recorder device.

### FIELD OF THE DISCLOSURE

The present disclosure generally relates to communications networks, and more particularly relates to a system and method for using short message service text messaging to schedule a recording of a television program.

### BACKGROUND

Many digital video recorders (DVRs) allow a user to remotely schedule a recording of a television program. The DVR can be part of a set-top box device that receives multiple television programs, or the DVR can be a separate device connected to the set-top box device. In either situation, the DVR provider and/or the television service provider can allow the user to access a user account associated with the DVR through a remote website in order to schedule the recording of the television program.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram illustrating an Internet Protocol Television (IPTV) system;

FIG. 2 is a block diagram of an exemplary network in the IPTV system;

FIGS. 3-6 are exemplary screen shots of a cellular telephone display;

FIG. 7 is a flow diagram of a method for receiving a record request;

FIG. 8 is a flow diagram of a method for sending the record request;

FIG. 9 is a flow diagram of a method for editing a list of scheduled recordings; and

FIG. 10 is a block diagram of a general computer system.

The use of the same reference symbols in different drawings indicates similar or identical items.

### DETAILED DESCRIPTION OF THE DRAWINGS

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily limit any of the various claimed inventions. Moreover, some statements may apply to some inventive features but not to others.

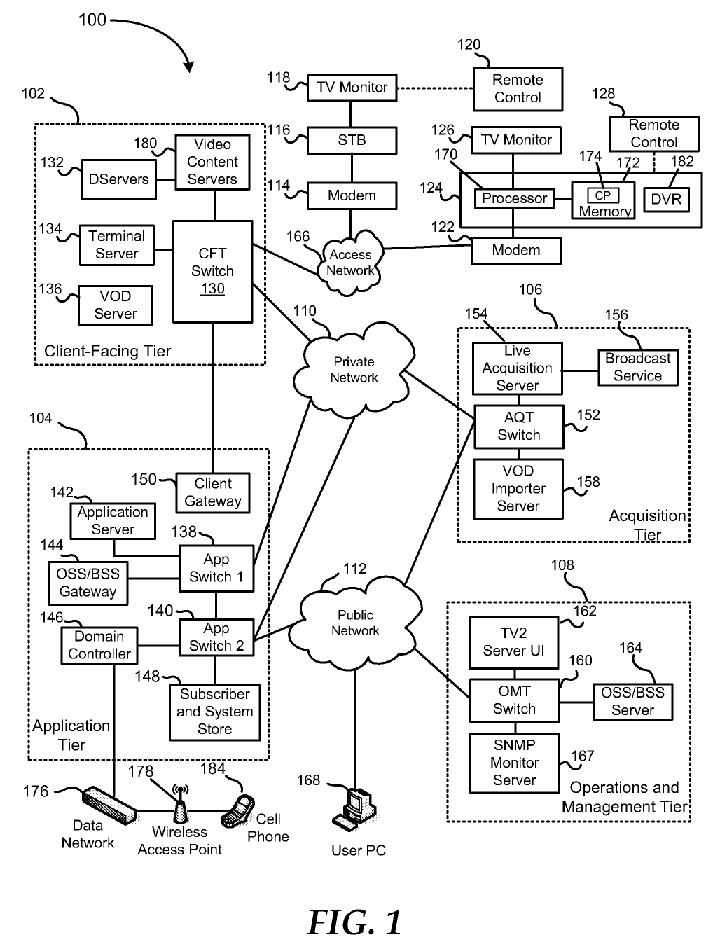

FIG. 1 shows an IPTV system 100 including a client facing tier 102, an application tier 104, an acquisition tier 106, and an operations and management tier 108. Each tier 102, 104, 106, and 108 is coupled to one or both of a private network 110 and a public network 112. For example, the client-facing tier 102 can be coupled to the private network 110, while the application tier 104 can be coupled to the private network 110 and to the public network 112 such as the Internet. The acquisition tier 106 can also be coupled to the private network 110 and to the public network 112. Moreover, the operations and management tier 108 can be coupled to the public network 112.

The various tiers 102, 104, 106 and 108 communicate with each other via the private network 110 and the public network 112. For instance, the client-facing tier 102 can communicate with the application tier 104 and the acquisition tier 106 via the private network 110. The application tier 104 can also communicate with the acquisition tier 106 via the private network 110. Further, the application tier 104 can communicate with the acquisition tier 106 and the operations and management tier 108 via the public network 112. Moreover, the acquisition tier 106 can communicate with the operations and management tier 108 via the public network 112. In a particular embodiment, elements of the application tier 104 can communicate directly with the client-facing tier 102.

The client-facing tier 102 can communicate with user equipment via a private access network 166, such as an Internet Protocol Television (IPTV) network. In an illustrative embodiment, modems such as a first modem 114 and a second modem 122 can be coupled to the private access network 166. The client-facing tier 102 can communicate with a first representative set-top box device 116 via the first modem 114 and with a second representative set-top box device 124 via the second modem 122. The client-facing tier 102 can communicate with a large number of set-top boxes over a wide geographic area, such as a regional area, a metropolitan area, a viewing area, or any other suitable geographic area that can be supported by networking the client-facing tier 102 to numerous set-top box devices. In one embodiment, the client-facing tier 102 can be coupled to the modems 114 and 122 via fiber optic cables. Alternatively, the modems 114 and 122 can be digital subscriber line (DSL) modems that are coupled to one or more network nodes via twisted pairs, and the client-facing tier 102 can be coupled to the network nodes via fiber-optic cables. Each set-top box device 116 and 124 can process data received from the private access network 166 via an IPTV software platform such as Microsoft® TV IPTV Edition.

The first set-top box device 116 can be coupled to a first display device 118, such as a first television monitor, and the second set-top box device 124 can be coupled to a second display device 126, such as a second television monitor. Moreover, the first set-top box device 116 can communicate with a first remote control 120, and the second set-top box device can communicate with a second remote control 128. In an exemplary, non-limiting embodiment, each set-top box device 116 and 124 can receive data or video from the client-facing tier 102 via the private access network 166 and render or display the data or video at the display device 118 or 126 to which it is coupled. The set-top box devices 116 and 124 thus may include tuners that receive and decode television programming information for transmission to the display devices 118 and 126. Further, the set-top box devices 116 and 124 can include a set-top box processor 170 and a set-top box memory device 172 that is accessible to the set-top box processor. In a particular embodiment, the set-top box devices 116 and 124 can also communicate commands received from the remote controls 120 and 128 back to the client-facing tier 102 via the private access network 166.

In an illustrative embodiment, the client-facing tier 102 can include a client-facing tier (CFT) switch 130 that manages communication between the client-facing tier 102 and the private access network 166 and between the client-facing tier 102 and the private network 110. As shown, the CFT switch 130 is coupled to one or more data servers 132 that store data transmitted in response to user requests, such as video-on-demand material. The CFT switch 130 can also be coupled to a terminal server 134 that provides terminal devices, such as a game application server and other devices with a common connection point to the private network 110. In a particular embodiment, the CFT switch 130 can also be coupled to a video-on-demand (VOD) server 136.

The application tier 104 can communicate with both the private network 110 and the public network 112. In this embodiment, the application tier 104 can include a first application tier (APP) switch 138 and a second APP switch 140. In a particular embodiment, the first APP switch 138 can be coupled to the second APP switch 140. The first APP switch 138 can be coupled to an application server 142 and to an OSS/BSS gateway 144. The application server 142 provides applications to the set-top box devices 116 and 124 via the private access network 166, so the set-top box devices 116 and 124 can provide functions such as display, messaging, processing of IPTV data and VOD material. In a particular embodiment, the OSS/BSS gateway 144 includes operation systems and support (OSS) data, as well as billing systems and support (BSS) data.

The second APP switch 140 can be coupled to a domain controller 146 that provides web access, for example, to users via the public network 112. The second APP switch 140 can be coupled to a subscriber and system store 148 that includes account information, such as account information that is associated with users who access the system 100 via the private network 110 or the public network 112. In a particular embodiment, the application tier 104 can also include a client gateway 150 that communicates data directly to the client-facing tier 102. In this embodiment, the client gateway 150 can be coupled directly to the CFT switch 130. The client gateway 150 can provide user access to the private network 110 and the tiers coupled thereto.

In a particular embodiment, the set-top box devices 116 and 124 can access the system via the private access network 166 using information received from the client gateway 150. The private access network 166 provides security for the private network 110. User devices can access the client gateway 150 via the private access network 166, and the client gateway 150 can allow such devices to access the private network 110 once the devices are authenticated or verified. Similarly, the client gateway 150 can prevent unauthorized devices, such as hacker computers or stolen set-top box devices, from accessing the private network 110 by denying access to these devices beyond the private access network 166.

For example, when the set-top box device 116 accesses the system 100 via the private access network 166, the client gateway 150 can verify subscriber information by communicating with the subscriber and system store 148 via the private network 110, the first APP switch 138 and the second APP switch 140. Further, the client gateway 150 can verify billing information and status by communicating with the OSS/BSS gateway 144 via the private network 110 and the first APP switch 138. The OSS/BSS gateway 144 can transmit a query across the first APP switch 138, to the second APP switch 140, and the second APP switch 140 can communicate the query across the public network 112 to the OSS/BSS server 164. After the client gateway 150 confirms subscriber and/or billing information, the client gateway 150 can allow the set-top box device 116 access to IPTV content and VOD content. If the client gateway 150 cannot verify subscriber information for the set-top box device 116, such as because it is connected to a different twisted pair, the client gateway 150 can deny transmissions to and from the set-top box device 116 beyond the private access network 166.

The acquisition tier 106 includes an acquisition tier (AQT) switch 152 that communicates with the private network 110. The AQT switch 152 can also communicate with the operations and management tier 108 via the public network 112. In a particular embodiment, the AQT switch 152 can be coupled to a live acquisition server 154 that receives television content, for example, from a broadcast service 156. Further, the AQT switch can be coupled to a video-on-demand importer server 158 that stores television content received at the acquisition tier 106 and communicate the stored content to the client-facing tier 102 via the private network 110.

The operations and management tier 108 can include an operations and management tier (OMT) switch 160 that conducts communication between the operations and management tier 108 and the public network 112. In the illustrated embodiment, the OMT switch 160 is coupled to a TV2 server 162. Additionally, the OMT switch 160 can be coupled to an OSS/BSS server 164 and to a simple network management protocol (SNMP) monitor 167 that monitors network devices. In a particular embodiment, the OMT switch 160 can communicate with the AQT switch 152 via the public network 112.

In a particular embodiment during operation of the IPTV system, the live acquisition server 154 can acquire television content from the broadcast service 156. The live acquisition server 154 in turn can transmit the television content to the AQT switch 152 and the AQT switch can transmit the television content to the CFT switch 130 via the private network 110. Further, the television content can be encoded at the D-servers 132, and the CFT switch 130 can communicate the television content to the modems 114 and 122 via the private access network 166. The set-top box devices 116 and 124 can receive the television content from the modems 114 and 122, decode the television content, and transmit the content to the display devices 118 and 126 according to commands from the remote control devices 120 and 128.

Additionally, at the acquisition tier 106, the VOD importer server 158 can receive content from one or more VOD sources outside the IPTV system 100, such as movie studios and programmers of non-live content. The VOD importer server 158 can transmit the VOD content to the AQT switch 152, and the AQT switch 152 in turn can communicate the material to the CFT switch 130 via the private network 110. The VOD content can be stored at one or more servers, such as the VOD server 136.

When a user issues a request for VOD content to the set-top box device 116 or 124, the request can be transmitted over the private access network 166 to the VOD server 136 via the CFT switch 130. Upon receiving such a request, the VOD server 136 can retrieve requested VOD content and transmit the content to the set-top box device 116 or 124 across the private access network 166 via the CFT switch 130. In an illustrative embodiment, the live acquisition server 154 can transmit the television content to the AQT switch 152, and the AQT switch 152 in turn can transmit the television content to the OMT switch 160 via the public network 112. In this embodiment, the OMT switch 160 can transmit the television content to the TV2 server 162 for display to users accessing the user interface at the TV2 server. For example, a user can access the TV2 server 162 using a personal computer (PC) 168 coupled to the public network 112.

The domain controller 146 communicates with the public network 112 via the second APP switch 140. Additionally, the domain controller 146 can communicate via the public network 112 with the PC 168. For example, the domain controller 146 can display a web portal via the public network 112 and allow users to access the web portal using the PC 168. Further, in an illustrative embodiment, the domain controller 146 can communicate with at least one wireless network access point 178 over a data network 176. In this embodiment, each wireless network access device 178 can communicate with user wireless devices such as a cellular telephone 184.

In a particular embodiment, the set-top box devices can include a set-top box computer program 174 that is embedded within the set-top box memory device 172. The set-top box computer program 174 can contain instructions to receive and execute at least one user television viewing preference that a user has entered by accessing an Internet user account via the domain controller 146. For example, the user can use the PC 168 to access a web portal maintained by the domain controller 146 via the Internet. The domain controller 146 can query the subscriber and system store 148 via the private network 110 for account information associated with the user. In a particular embodiment, the account information can associate the user's Internet account with the second set-top box device 124. For instance, in an illustrative embodiment, the account information can relate the user's account to the second set-top box device 124 by associating the user account with an IP address of the second set-top box device, with data relating to one or more twisted pairs connected with the second set-top box device, with data related to one or more fiber optic cables connected with the second set-top box device, with an alphanumeric identifier of the second set-top box device, with any other data that is suitable for associating the second set-top box device with a user account, or with any combination of these.

The set-top box computer program 174 can contain instructions to receive many types of user preferences from the domain controller 146 via the access network 166. For example, the set-top box computer program 174 can include instructions to receive a request to record at least one television program at a video content storage module such as a digital video recorder (DVR) 182 within the second set-top box device 124. In this example embodiment, the set-top box computer program 174 can include instructions to transmit the request to the DVR 182, where the television program(s) are recorded. In an illustrative embodiment, the set-top box computer program 174 can include instructions to receive from the DVR 182 a recording status with respect to one or more of the television programs and to transmit at least one message regarding the status to a wireless device, such as the cellular telephone 184. The message can be received at the CFT switch 130, for instance, and communicated to the domain controller 146 across the private network 110 via the second APP switch 140. Further, the domain controller 146 can transmit the message to the wireless data network 176, directly or via the public network 112, and on to the wireless network access point 178. The message can then be transmitted to the cellular telephone 184. In an illustrative embodiment, the status can be sent via a wireless access protocol (WAP).

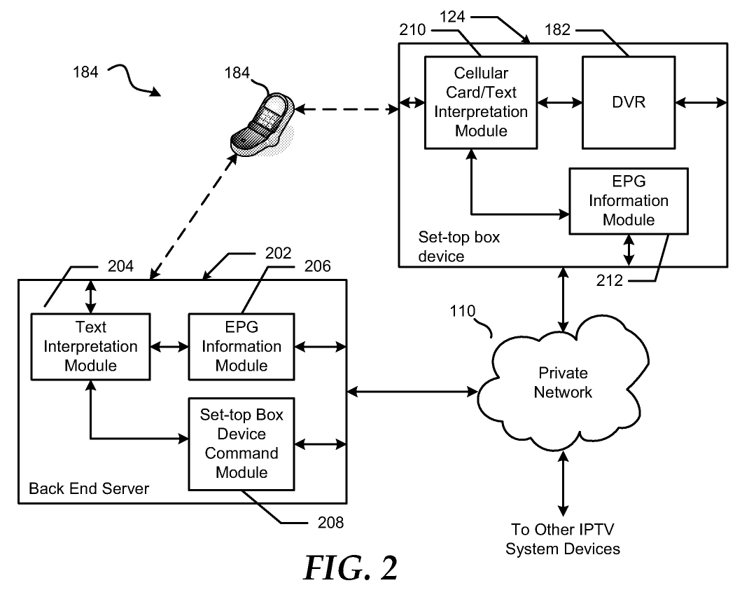

FIG. 2 shows a block diagram of an exemplary network 200 comprising a back end server 202, the set-top box device 124, the cellular telephone 184, and the private network 110. The back end server 202 includes a text interpretation module 204, an electronic programming guide (EPG) information module 206, and a set-top box device command module 208. The set-top box device 124 includes a cellular card/text interpretation module 210, an EPG information module 212, and the DVR 182. In various embodiments the modules can be incorporated in hardware, software, or a combination of hardware and software. The back end server 202 is in communication with the cellular telephone 184 via a wireless connection and is in communication with the set-top box device 124 via the private network 110. The cellular telephone 184 is in communication with the set-top box device 124 via a wireless connection.

In the back end server 202, the text interpretation module 204 is in communication with the EPG information module 206 and with the set-top box device command module 208. The EPG information module 206 can communicate with other IPTV system devices through the private network 110 to receive EPG information for different television programs provided by the IPTV system 100. The EPG information can include the name of the television program, the television channel name, and the time that the television program is going to be provided. The set-top box device command module 208 can send different commands to the DVR 182 of the set-top box device 124 through the private network 110. In the set-top box device 124, the cellular card/text interpretation module 210 is in communication with the EPG information module 212, and with the DVR 182. The EPG information module 206 can communicate with other IPTV system devices through the private network 110 to receive EPG information for the different television programs provided by the IPTV system 100.

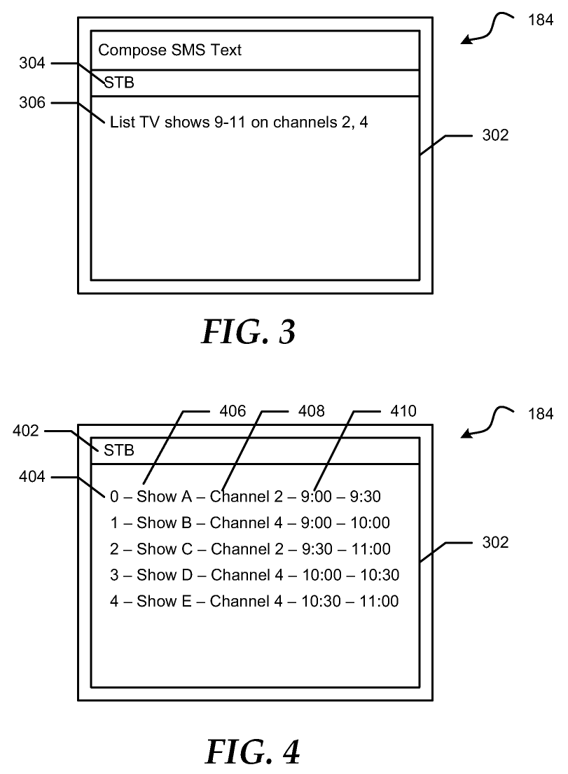

While away from the set-top box device 124, a user can utilize the cellular telephone 184 to schedule a recording on the set-top box device. The user can send a short message service (SMS) text message associated with a record command for a specific television program to either the back end server 202 or the set-top box device 124. Upon receiving the record command, the back end server 202 or the set-top box device 124 can schedule the recording in the DVR 182. However, if the user cannot remember an exact time or television channel for the television program, the user can send an SMS text message requesting a list of television programs that are going to be provided on a number of television channels during a specific time period. For example, FIG. 3 shows an exemplary screen shot of a display device 302 for the cellular telephone 184 including a recipient 304 and a command text message 306. The user can compose the command text message 306 requesting a list of television programs scheduled to be provided on channels two and four from nine to eleven o'clock pm. The recipient 304 for the SMS text message can be either the back end server 202 or the set-top box device 124. Upon receiving the SMS text message the back end server 202 and the set-top box device 124 can authenticate the user sending the SMS text message to a user account associated with the set-top box device and/or an external DVR device.

If the SMS text message is transmitted to the back end server 202, the text interpretation module 204 can receive the SMS text message and determine the command requested by the user. For example, the text interpretation module 204 could determine that the user was requesting the list of television programs scheduled to be provided on a number of television channels during a specific time period. This command can be transmitted to the EPG information module 206 to receive EPG information for the requested television programs. The EPG information module 206 can communicate with other IPTV system devices, via the private network 110, to determine the list of television programs scheduled to be provided. The other IPTV system devices can be live acquisition server 154, the video content servers 180, and the like as shown in FIG. 1.

Upon the EPG information module 206 receiving the associated EPG information, the list of television programs can be sent to the cellular telephone 184 as an SMS text message. Upon receiving the SMS text message of the list of television programs, the SMS text message can be output on the display device 302 as shown in FIG. 4. The list of television programs SMS text message can include a sender 402, a display number 404, a television program name 406, a television channel name 408, and a program time 410. The sender 402 can be either the back end server 202 or the set-top box device 124. The user can utilize the display number 404, such as ‘0,’ during the process of selecting one of the television programs. The program name 406, the channel name 408, and the program time 410 can provide the user with the EPG information for the different television programs, so that the user can decide which television program or programs he wants to record.

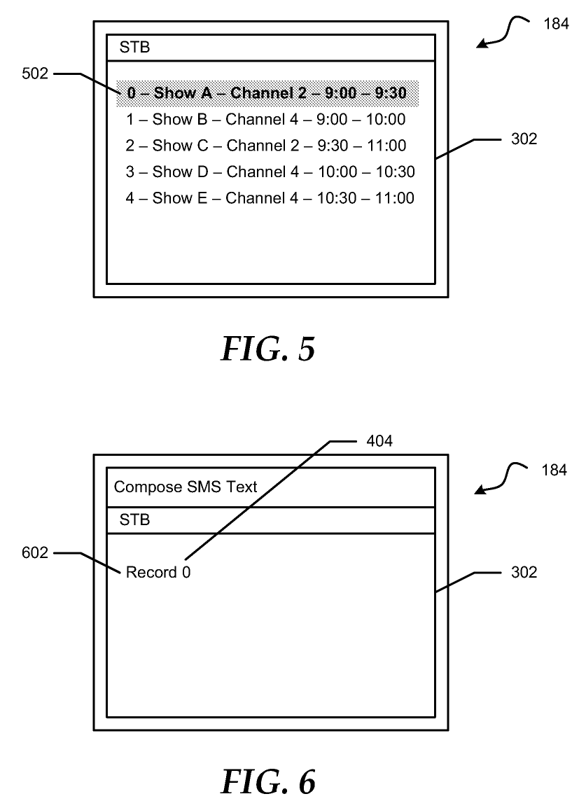

Upon deciding which television program or programs to record, the user can select the desired program. One way that the user can select a television program is by highlighting EPG information 502 on the display device 302 as shown in FIG. 5. The EPG information 502 can be selected by using directional keys (not shown) on the cellular telephone 184 to scroll through the list of television programs until the desired EPG information is highlighted and then pressing a select button (not shown) on the cellular telephone. The EPG information 502 can also be selected by finger or stylus pressure if the display device 302 is touch sensitive. The cellular telephone 184 can recognize an activation of the portion of the touch screen as the selection of the desired television program. Additionally, upon the user selecting the desired television program, the cellular telephone 184 can automatically send an SMS text message containing a record request for the desired television program to the back end server 202. The user can also manually send the record request for the desired television program by sending an SMS text message 602 with the display number 404 as the record request as shown in FIG. 6.

Upon the back end server 202 receiving the record request SMS text message, the text interpretation module 204 can transmit the record request to the set-top box device command module 208. The record request can then be sent from the set-top box device command module 208 to the DVR 182 via the private network 110. Upon receiving the record request, the DVR 182 can store the record request for the associated television program as a scheduled recording.

The user can also send an SMS text message to the back end server 202 requesting a list of television programs scheduled to be recorded by the DVR 182. Upon the text interpretation module 204 receiving the request, the set-top box device command module 208 can send the request to the set-top box device 182 to receive the list of television programs scheduled to be recorded. The back end server 202 can send the list of television programs scheduled to be recorded as an SMS text message to the cellular telephone 184. The user can then select a television program to either delete or to change a recording setting from the list of television programs scheduled to be recorded. The deletion of a scheduled recording or the change of the recording setting can then be sent to the text interpretation module 204, and this request can then be sent to the DVR 182 via the set-top box device command module 208.

The interface between the cellular telephone 184 and the set-top box device 124 to set a television program to record is performed in substantially the same manner as the interface between the cellular telephone and the back end server 202. If the SMS text message is transmitted to the set-top box device 124, the cellular card/text interpretation module 210 can receive the SMS text message and determine the command requested by the user. The cellular card/text interpretation module 210 can also provide the set-top box device 124 with the ability to connect to a cellular communication network, so that the cellular telephone 184 can communicate directly with the set-top box device. The command can be transmitted to the EPG information module 212, which can communicate with other IPTV system devices via the private network 110 to determine the list of television programs scheduled to be provided.

Upon the EPG information module 212 receiving the associated EPG information, the list of television programs can be sent to the cellular telephone 184 as an SMS text message. Upon receiving the SMS text message of the list of television programs, the SMS text message can be output on the display device 302 as shown in FIG. 4. Upon deciding which television program or programs to record, the user can select the desired program. The cellular telephone 184 can then automatically send an SMS text message containing a record request for the desired television program. The user can also manually send the record request for the desired television program to the set-top box device 124. Upon the set-top box device 124 receiving the record request SMS text message, the cellular card/text interpretation module 210 can transmit the record request to the DVR 182. Upon receiving the record request, the DVR 182 can store the record request for the associated television program as a scheduled recording. The set-top box device 124 can also directly interface with the cellular telephone 184 to provide the list of scheduled recordings, to delete a scheduled recording, and to change a setting on a scheduled recording.

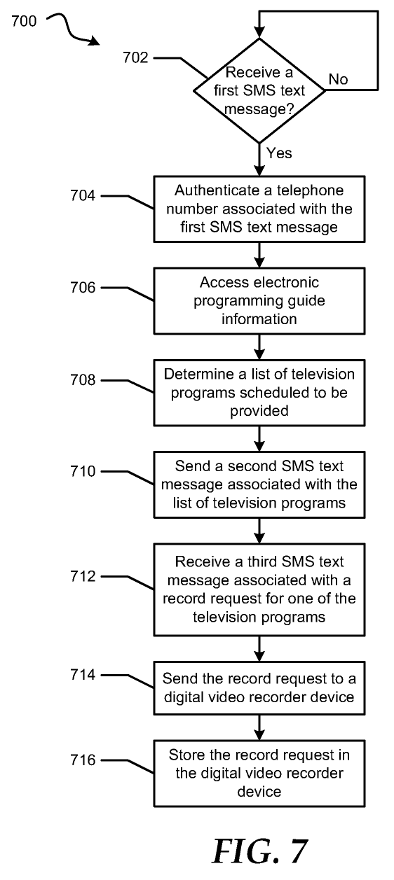

The back end server 202 and the set-top box device 124 can receive SMS text messages requesting EPG information and requesting that a particular television program be recorded. FIG. 7 shows a flow diagram of a method 700 for setting a television program to be recorded. At block 702, a determination is made whether a first SMS text message is received. The SMS text message can be associated with a request for a list of television programs scheduled to be provided. At block 704, a telephone number associated with the SMS text message is authenticated. If the first SMS text message is received, electronic programming guide information is accessed at block 706. The list of television programs scheduled to be provided is determined at block 708. At block 710, a second SMS text message associated with the list of television programs is sent. A third SMS text message associated with a record request for one of the television programs is received at block 712. At block 714, the record request is sent to a DVR device. The DVR device can be part of a set-top box device or a separate device in communication with the set-top box device. At block 716, the record request is stored the DVR device.

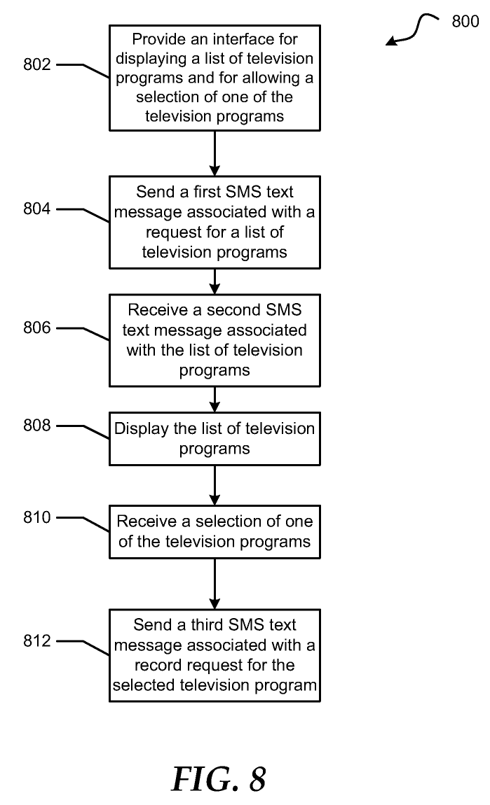

The cellular telephone 184 can be used to send a record request for a particular television program as a SMS text message. FIG. 8 shows a flow diagram of a method 800 for communicating with a set-top box device through a SMS text message. At block 802, an interface for displaying a list of television programs and allowing a selection of one of the television programs is provided. At block 804, a first SMS text message associated with a request for a list of television programs is sent. A second SMS text message associated with the list of television programs is received at block 806. At block 808, the list of television programs is displayed. A selection of one of the television programs is received at block 810. The selection can be an input of a number corresponding to the one of the television programs, activation of a portion of a touch screen corresponding to the one of the television programs, highlighting the one of the television programs and select button being pressed, and the like. At block 812 a third SMS text message associated with a record request for the selected television program is sent.

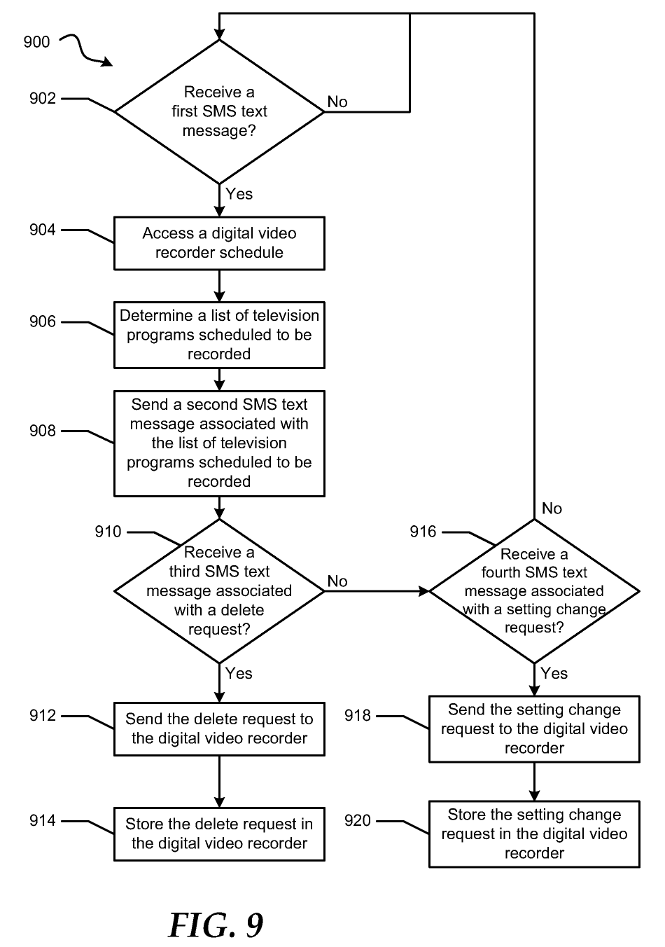

The back end server 202 and the set-top box device 124 can send and receive SMS text messages to display a list of scheduled recordings, to delete a scheduled recording, and to change a setting on a scheduled recording. FIG. 9 shows a flow diagram of a method 900 for editing a list of scheduled recordings. At block 902, a first SMS text message associated with a request for a list of scheduled recordings is received. A digital video recorder schedule is accessed at block 904. At block 906, a list of television programs scheduled to be recording is determined. A second SMS text message associated with the list of television programs scheduled to be recorded is sent to a cellular telephone at block 908. At block 910, a determination is made whether a third SMS text message associated with a delete request for one of the television programs in the list of scheduled recordings is received.

If the third SMS text message associated with the delete request is received, the delete request is sent to the digital video recorder at block 912. At block 914, the delete request is stored in the digital video recorder. If the third SMS text message associated with the delete request is not received, a determination is made whether a fourth SMS text message associated with a setting change request is receive at block 916. At block 918, if the fourth SMS text message associated with a setting change request is not received, the flow diagram continues as stated above at block 902. If the fourth SMS text message associated with a setting change request is received, the setting change request is sent to the digital video recorder at block 918. At block 920, the setting change request is stored in the digital video recorder.

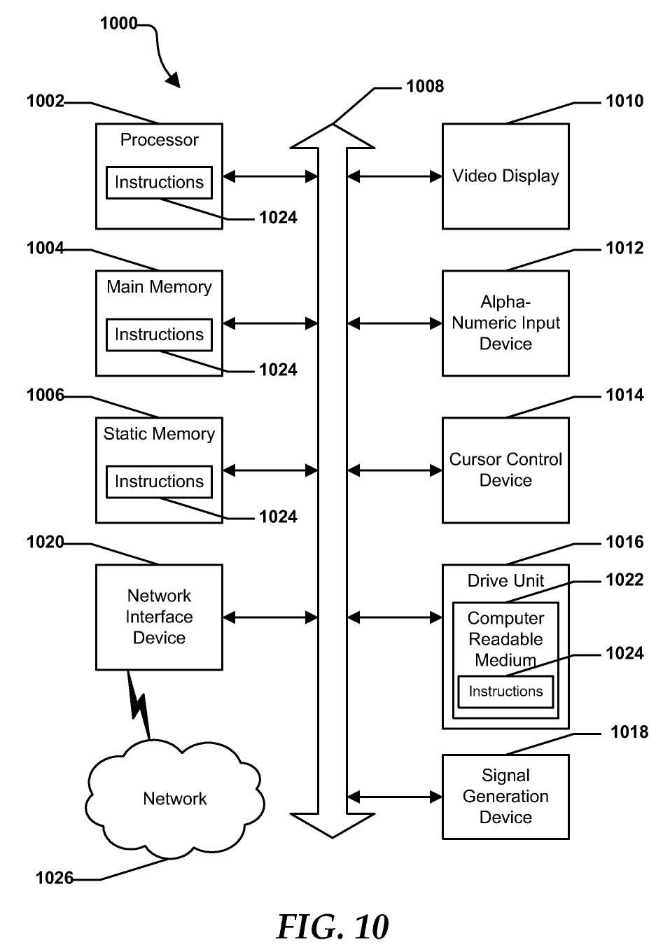

FIG. 10 shows an illustrative embodiment of a general computer system 1000 in accordance with at least one embodiment of the present disclosure. The computer system 1000 can include a set of instructions that can be executed to cause the computer system to perform any one or more of the methods or computer based functions disclosed herein. The computer system 1000 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 1000 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 1000 can be implemented using electronic devices that provide voice, video or data communication. Further, while a single computer system 1000 is illustrated, the term “system” shall also be taken to include any collection of systems or sub-systems that individually or jointly execute a set, or multiple sets, of instructions to perform one or more computer functions.

The computer system 1000 may include a processor 1002, e.g., a central processing unit (CPU), a graphics processing unit (GPU), or both. Moreover, the computer system 1000 can include a main memory 1004 and a static memory 1006 that can communicate with each other via a bus 1008. As shown, the computer system 1000 may further include a video display unit 1010, such as a liquid crystal display (LCD), an organic light emitting diode (OLED), a flat panel display, a solid state display, or a cathode ray tube (CRT). Additionally, the computer system 1000 may include an input device 1012, such as a keyboard, and a cursor control device 1014, such as a mouse. Alternatively, the input device 1012 and the cursor device 1014 can be combined in a touchpad or touch sensitive screen. The computer system 1000 can also include a disk drive unit 1016, a signal generation device 1018, such as a speaker or remote control, and a network interface device 1020.

In a particular embodiment, as depicted in FIG. 10, the disk drive unit 1016 may include a computer-readable medium 1022 in which one or more sets of instructions 1024, e.g. software, can be embedded. Further, the instructions 1024 may embody one or more of the methods or logic as described herein. In a particular embodiment, the instructions 1024 may reside completely, or at least partially, within the main memory 1004, the static memory 1006, and/or within the processor 1002 during execution by the computer system 1000. The main memory 1004 and the processor 1002 also may include computer-readable media. The network interface device 1020 can provide connectivity to a network 1026, e.g., a wide area network (WAN), a local area network (LAN), or other network.

In an alternative embodiment, dedicated hardware implementations such as application specific integrated circuits, programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 1024 or receives and executes instructions 1024 responsive to a propagated signal, so that a device connected to a network 1026 can communicate voice, video or data over the network 1026. Further, the instructions 1024 may be transmitted or received over the network 1026 via the network interface device 1020.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the FIGs. are to be regarded as illustrative rather than restrictive.

The Abstract of the Disclosure is provided to comply with 37 C.F.R. § 1.72(b) and is submitted with the understanding that it will not be used to interpret or limit the scope or meaning of the claims. In addition, in the foregoing Detailed Description of the Drawings, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description of the Drawings, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosed subject matter. Thus, to the maximum extent allowed by law, the scope of the present disclosed subject matter is to be determined by the broadest permissible interpretation of the following claims and their equivalents, and shall not be restricted or limited by the foregoing detailed description.

What is claimed is:

1. A method comprising:
receiving a first short message service text message associated with a request for a list of television programs scheduled to be provided;
sending a second short message service text message associated with the list of television programs scheduled to be provided;
receiving a third short message service text message associated with a record request for a selected television program in the list of television programs; and
sending the record request for the selected television program to a digital video recorder device.

2. The method of claim 1 further comprising:
accessing an electronic program guide information to determine the list of television programs scheduled to be provided.

3. The method of claim 1 wherein the first and third short message service text messages are received at a server of a television program provider.

4. The method of claim 1 wherein the record request is a programming code associated with the television program.

5. The method of claim 1 wherein the digital video recorder is part of a set-top box device.

6. The method of claim 1 further comprising:
authenticating a telephone number associated with the first short message service text message prior to determining the list of television programs scheduled to be provided.

7. A method comprising:
sending a first short message service text message associated with a request for a list of television programs scheduled to be provided;
receiving a second short message service text message associated with the list of television programs scheduled to be provided;
displaying the list of television programs scheduled to be provided;
receiving a selection of one of the television programs scheduled to be provided; and
sending a third short message service text message associated with a record request for the selection of the television program from the list of television programs.

8. The method of claim 7 wherein receiving the selection of one of the television programs comprises:
receiving an input of a number corresponding to the one of the television programs.

9. The method of claim 7 wherein receiving the selection of one of the television programs comprises:
determining that a portion of a touch screen corresponding to the one of the television programs is activated.

10. The method of claim 7 wherein receiving the selection of one of the television programs comprises:
receiving a request to highlight the one of the television programs; and
receiving an input corresponding to a selection button.

11. The method of claim 7 wherein the record request is a programming code associated with the television program.

12. A method comprising:
receiving a first short message service text message associated with a request for a list of television programs scheduled to be recorded;
sending a second short message service text message associated with the list of television programs scheduled to be recorded;
receiving a third short message service text message associated with a delete request for a first selected television program in the list of television programs; and
sending the delete request for the first selected television program to a digital video recorder device.

13. The method of claim 12 wherein the first and third short message service text messages are received at a server of a television program provider.

14. The method of claim 12 wherein the delete request is a programming code associated with the television program.

15. The method of claim 12 wherein the digital video recorder is part of a set-top box device.

16. The method of claim 12 further comprising:
receiving a fourth short message service text message associated with a setting change request for a second selected television program in the list of television programs; and
sending the setting change request for the second selected television program to a digital video recorder device.

17. A device comprising:
a memory configured to store a plurality of instructions; and
a processor in communication with the memory, the processor configured to execute the plurality of instructions comprising:
instructions to send a first short message service text message associated with a request for a list of television programs scheduled to be provided;
instructions to receive a second short message service text message associated with the list of television programs scheduled to be provided;
instructions to provide an interface for displaying the list of television programs scheduled to be provided and allowing a selection of one of the television programs; and
instructions to send a third short message service text message based on the selection of one of the television programs.

18. The device of claim 17 wherein receiving the selection of one of the television programs comprises:
instructions to receive an input of a number corresponding to the one of the television programs.

19. The device of claim 17 wherein receiving the selection of one of the television programs comprises:
instructions to determine that a portion of a touch screen corresponding to the one of the television program is activated.

20. The device of claim 17 wherein receiving the selection of one of the television programs comprises:
instructions to receive a request to highlight the one of the television programs; and
instructions to receive an input corresponding to a selection button.

21. The device of claim 17 wherein the record request is a programming code associated with the television program.

22. A set-top box device comprising:
a memory configured to store a plurality of instructions; and
a processor in communication with the memory, the processor configured to execute the plurality of instructions comprising:
instructions to receive a first short message service text message associated with a request for a list of television programs scheduled to be provided;
instructions to determine the list of television programs scheduled to be provided;
instructions to send a second short message service text message associated with the list of television programs scheduled to be provided;
instructions to receive a third short message service text message associated with a record request for a selected television program in the list of television programs; and
instructions to store the record request for the selected television program.

23. The set-top box device of claim 22 further comprising:
instructions to access an electronic program guide information to determine the list of television programs scheduled to be provided.

24. The set-top box device of claim 22 wherein the record request is a programming code associated with the television program.

25. The set-top box device of claim 22 wherein the instructions to store the record request further comprises instructions to the send the record request to an external digital video recorder.
